(19) United States
(12) Patent Application Publication
(10) Pub. No.: US 2003/0012861 A1
(43) Pub. Date: Jan. 16, 2003

(54) Proteinaceous food based on hempseed and/or other plants, that keeps the seed's nutritional value and does not use dangerous ingredients, such as preservatives or coloring

(76) Inventor: Yaron Mayer, Jerusalem (IL)

Correspondence Address: YARON MAYER, 21 AHAD HA'Am ST., JERUSALEM, 92151, IL

(21) Appl. No.: 10/172,889

(22) Filed: Jun. 13, 2002

(30) Foreign Application Priority Data
Jun. 13, 2001 (IL) 143738

(51) Int. Cl. A23L 1/36

(52) U.S. Cl. 426/629

(57) ABSTRACT

A composition and method of preparing proteinaceous health food, preferably based on or including hempseed, that keeps the seed's nutritional value, preferably by preparation under conditions of little or no oxygen, little or no light, and low temperatures, and does not use dangerous ingredients, such as preservatives or coloring. Various variations of this food can be used for example for pet food, for other animals feed, for humans, or for baby formulas. Although hempseed is the best example, the present invention may be used also with other proteinaceous plants that don't have the problems of soy, such as for example flax seed or sesame, or some combination of the above. Other features are preferably avoiding any cooking (at least in variations for pet foods) so that the ingredients are not denaturated, and preferably dividing the product into individual encased servings, preferably each opaque to air and light, within the external package, preferably with different types of servings, so that the diet is balanced across servings but not the same within each serving.

1. Field of the invention

The present invention relates to healthy nutrition, and more specifically to proteinaceous health food, preferably based on hempseed, that keeps the seed's nutritional value and does not use dangerous ingredients, such as preservatives or coloring.

2. Background

The use of vegetable proteins in Proteinaceous foods both for humans and for pets, and especially carnivores, like dogs and cats, has become very popular for many years, in order to save production costs, reduce cholesterol (compared to consuming beef for example), for the convenience of using pre-prepared food, and for ecological reasons, since feeding animals and humans with plant protein is much more efficient than feeding animals and then consuming their meat.

Unfortunately, according to the claims in the publications listed below, in the recent years it has been discovered that Soy, which is the most commonly used vegetable protein today, may be in fact much more damaging than meat or milk, because Soy is a nasty plant that contains anti-nutrients and especially isoflavones, which are designed to damage animals that feed on it. It can reduce the growth of animals that eat it and can damage the brain by reducing tyrosine enzymes activity, which can disturb the activity of the hippocampus (a brain region involved with learning and memory) and of the thyroid gland and disturb the utilization rate of dopamine, and by Phytates that reduce the ability to absorb important minerals, such as for example zinc, which is important for the brain. The Isovlavones are also Phytoestrogens, which means that they can mimic human Estrogens, and they can interfere with the mammalian hormones involved in reproduction and growth—a strategy to reduce the number and size of animals that eat the plant, and might also decrease brain calcium-binding proteins. This can be especially damaging for example to babies that are fed a soy-based formula instead of mother's milk. Also, there are other proteins found in soybeans which can act as enzyme inhibitors and thus block the action of Trypsin and other enzymes needed for protein digestion. (See for example: “The Trouble With Tofu: Soy and the Brain” by John D. MacArthur (http ://www.mercola.com/2000/sept/17/soy brain.htm), Soy Online Service (http://www.soyonlineservice.co.nz), and “Tragedy and Hype: The Third International Soy Symposium” in Nexus Magazine, Vol. 7, Number 3 (April-May 2000) (http://www.nexusmagazine.com/ soydangers.html). In order to reduce these toxins, Soy beans have to be fermented in water for a long time (preferably at least for 10 hours) before further processing and need to be cooked for preferably at least 1 hour (but this also denatures the proteins, thus making them more difficult to digest), and even this does not get rid of these toxins completely but only reduces their quantities. Unfortunately, there is no standard or supervision that forces producers of various soy products to fully or even partially implement these toxin reduction procedures, nor to report on the label what and how much effort has been done for reducing the amount of these toxins or what percent of the toxins remains in the products. Therefore, there is a large variance in the levels of toxins found in various soy products on shelves, and in Israel for example some dealers even sell dry roasted soybeans, which may be without any toxin reduction at all. What makes matters even worse is the fact that manufacturers are not even required to label the fact that soy ingredients are included at all, so many times the label just states “vegetable oil”, and many times this “vegetable oil” is actually soy oil, since it is the cheapest oil. So even people buying for example just some types of chocolate spreads that contain for example about 30% “vegetable oil” might actually be buying inadvertently a product that contains 30% soy oil, with unknown amounts of these toxins. In addition to this, soy has a problem of having a taste that most people dislike, so various additional processing or additions of other ingredients are required in order to make the taste more acceptable to humans and to animals. Also, there is a controversy about genetically modified Soy. In new Zealand there is now an attempt to file a large class action suit against the soy industry, and similar lawsuits will probably follow in other places, such as the USA and Europe.

In the pet food industry the state-of-the-art situation might be even worse, since in order to save production costs to minimum, some producers might try to shorten the processing time to minimum, thus leaving higher quantities of the toxins in the soy. In addition to this, in order to make these products palatable to animals, industrial soy-based pet foods may contain also some meat or meat by-products (which may be of low quality, in order to save costs) and may contain various chemicals, such as preservatives, colors, and artificial flavors. Also, it is very hard to find really healthy alternatives other than giving pets (and especially dogs and cats) human foods (such as for example preferably raw meat and bones of chickens), since pet foods that are more meat-based typically contain low level meat and various unhealthy chemicals. Also, they are typically thoroughly cooked at levels that can destroy most of the nutritional value. The result is that many pets that are fed industrial junk food may develop human-like diseases such as cancer, heart disease or diabetes, whereas pets that are fed foods suitable for human consumption and especially raw meat and bones (for example dogs) are typically healthier and happier and need less visits to the vet, and live longer.

Clearly a better vegetable protein alternative is needed for humans that wish to consume less animal meat, and clearly a healthy alternative is needed for commercial pet food. Also, the state of the art is selling pet foods in either relatively dry form typically in nylon bags, or moist pet food in cans, but there is no inherent reason why not to add also the option of more fresh, refrigerated pet food.

### SUMMARY OF THE INVENTION

The present invention tries to solve the above problems by providing a much healthier alternative both for humans and for animals and with less problems. This solution is based on using hempseed (and/or other proteinaceous plants that don't have the problems of soy, such as for example flax seed or sesame) instead of soybeans. Hempseeds contain almost as much protein as Soy, but have a much higher nutritional value because:

a. They don't contain the toxins that are found in soy.

b. The proteins are more complete and easier to assimilate.

c. They contain Essential Fatty Acids (EFA's), and especially Omega 3 (Linolenic Acid—LNA) and Omega 6 (Linoleic Acid—LA) in the optimal ratio of 1:3, and also Omega 6 Gamma-Linoleic-Acid (GLA), and other important nutrients and minerals. These nutrients are very important for the development of the brain (and especially for example for babies or puppies) and for growth, and can prevent a lot of immunological problems, and can also reduce the chance for heart disease and cancer, which are the main killers of the 20^{th} century, and also for other degenerative diseases, such as Diabetes and Multiple Sclerosis. They can also reduce problems such as hyperactivity, learning disabilities, or attention disorders. In fact, the main hempseed protein is called Edestin, which is the root word upon which the Greeks based their model of the most edible food. Flax seeds for example also contain Omega 3 & Omega 6, but not in this optimal ratio.

d. Unlike Soy, which is hard to grow organically (and therefore organic Soy is more expensive and harder to get), hemp is a very sturdy plant which can be easily grown without any pesticides, and requires little or no fertilizers, so organically grown hemp can be much cheaper and much more prevalent.

e. They have a very good taste even without any special treatment or additives.

The hemp seeds don't contain the mind-altering THC that can be found in the female flowers or leaves, so there is no drug problem. Also, unlike in the USA, industrial hemp (that has a very low TCH content even in the flowers and leaves) can be and is now legally grown in most of the civilized world, such as in Canada, England, Germany, France, Eastern Europe (and especially Russia and Romania), China, India, and South America. Therefore, almost every food item that contains Soy can be replaced with hemp. However, since, unlike Soy, hemp does not contain damaging toxins that need to be reduced and in fact contains many important nutrients, and especially the Essential Fatty Acids, it is preferable not to use the same processes that are used with soy, and also preferably not to remove the oil or remove only part of it. There have been some recent attempts to create a relatively pure protein isolate from hemp seed, however for the above reasons it seems like an unnecessary an undesirable procedure. Birds and fish for example love to eat the seed as is, so no processing is needed for them. However, in food for carnivorous pets, such as dogs and cats, it might still be desirable to remove at least some of the fats in order to make the seeds taste more protein-like or meat-like. On the other hand, hempseed has some problems that Soy does not have, and especially the fact that since its oil is so good for bio-organisms, it can easily become rancid if not kept in an oxygen-free and light-free environment or if heated. Another problem is that hempseeds have a strong shell with lower nutritional value, which is harder to remove than in other grains, and can for example cause inconvenience by getting stuck in the teeth. Therefore the shell is preferably removed as much as possible, preferably by better or more efficient methods than those used with normal seeds. However, another possible variation is to leave the shell in the food (for example for its value as fiber-rich food), but preferably crash it and mix it together with the seed to ensure digestion of all the components.

There are a number of related patents by Udo Erasmus (mainly U.S. Pat. Nos. 6,165,539, 5,656,312, 6,007,860, and 6,001,401), however, these patents relate mainly to Flax seeds, they do not deal with dehydration or oil extraction, they do not mention shell removal, and they are typically limited to a process of less than 20 minutes duration and temperatures of lees than 100 degrees F. Also, these patents do not include for example the option of keeping away oxygen during the production process itself, which can be used for example for making temperature requirements and/or time requirements more flexible, especially if temperature is raised for example for only very short times. Nor do these patents include the option of preparing relatively dry, relatively solid, healthy snacks in various shapes, so that they can compete directly with the state of the art soy or meat dry-food snacks. And these patents deal with oily seed food supplements, not with balanced independent foods.

Therefore, the invention preferably contains at least some of the following main elements:

1. For both humans and animals, preferably first the hempseed shells are removed, preferably by mechanical means. Another possible variation is allowing the seeds to start partially sprouting, which improves digestibility and naturally splits the shells, so that they can be removed for example by water agitation. Another possible variation is soaking the seeds for some time in water and preferably also using various enzymes to soften and/or remove the shell. In this case is the shells are preferably dried before the removal in order not to add additional water to the seeds. Of course, various combinations of these and additional methods can also be used. This shelling of the seeds is preferably done in conditions of room temperature or lower temperatures and with as little light or no light and as little oxygen or no oxygen as possible, in order to reduce the chance for oxidation. Another possible variation is for example to crunch the seeds with the shells and mix them together with the shells.

2. For carnivorous animals food (such as dogs and cats) preferably only part of the hempseed's oil is removed (preferably by cold-pressing and without chemical extraction, in order to avoid using possibly dangerous chemical solvents which might leave some traces) in order to keep as much nutritients as possible but still increase the relative percent of protein. The shells or remains of the shells can also be further removed at this stage since this pressing can further break them apart. This pressing of oils is preferably done in conditions of room temperature or lower temperatures and with as little light or no light and as little oxygen or no oxygen as possible, in order to reduce the chance for oxidation. Another possible variation is not to remove the oil at all.

3. In order to extend shelf life, the seeds are preferably at least partially dehydrated to a certain degree in order to reduce water activity, and preferably the dehydration process can be short—preferably less than half an hour, so that it does not damage the nutrients or the flavor. Preferably some natural healthy anti-oxidants can also be added at this stage, such as for example Vitamin C, Vitamin E, Vitamin A, or rice bran. For pet foods, additional elements, such as for example meat (for example as dried powder) (preferably chicken or fish meat) and/or bones (for example as dried powder) can also be added at this stage in order to increase palatability for carnivore pets. Adding these elements that can increase the protein-like taste of the seeds can also be used instead of reducing the oil content of the seeds. Some other seeds, such as for example flax, primrose, or sesame seed can also be added in order to further enrich the taste and/or add additional nutrients. Also, other nutrients can be added, such as for example various vitamin and/or mineral supplements. Also various starches can be added in order to increase the satiating ability of the products. Another possible variation is that preferably, before or during or after the partial dehydration (or without the dehydration), the material is passed through a pressure-extruding equipment in order to be able to shape it in forms more pleasant for humans or for animals. This pressure is preferably not too strong, so as not to damage the nutrients. Preferably the entire process of stage 3 is also done in conditions of room temperature or lower temperatures and with as little light or no light and as little oxygen or no oxygen as possible.

4. The seeds are then preferably packed in oxygen-free and light-opaque packaging, for example by vacuum packing and/or by filling it with other gases, such as for example Nitrogen or Argon or Carbon Dioxide, instead of normal air. If the oil was extracted, then preferably the extracted oil is preferably similarly packaged separately in order to prevent rancidity, and can be sold for example together with the seedbased food, in its separate package. This gives the consumer the added ability to decide independently if and how much oil to add back to the food before consumption, depending for example if it is used for human consumption or for animals, and, if animals, whether they are carnivore animals or not. This flexibility is also different from the current state-of-the-art for example in pet foods. However, at least after opening the package, the product is preferably kept refrigerated, since the conditions of excluding oxygen and light no longer apply. Therefore, another possible variation is that the food is preferably divided into smaller compartments within the larger package, each preferably at the size of one serving, such as for example in small sized plastic or nylon envelopes, each of them preferably also opaque to light and without oxygen, so that opening the food exposes only the small amount in the smaller compartment. In addition, preferably not all servings are the same, so that the diet is preferably balanced between servings and not within each serving. This is very different from the current state of the art.

Important Clarification and Glossary

All the illustrations are just examples and should not be interpreted as limiting. Throughout the patent when possible variations are mentioned, it is also possible to use combinations of these variations, and when combinations are used, it is also possible to use at least some elements in them separately. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable sub-combination. Eventhough most animal examples have been used regarding pets, this food processing can be similarly applied also to other animals. Eventhough the patent has been described mainly with reference to hemp seed, since hempseed is the best example, the present invention may be used also with other proteinaceous plants that don't have the problems of soy, such as for example flax seed or sesame.

### DETAILED DESCRIPTION OF THE PREFERRED EMBODIMENTS

All of the descriptions in this and other sections are intended to be illustrative examples and not limiting.

Since this patent deals with a method of preparing food and the composition of such food, as is customary in this area, instead of drawings, examples of the method and of the possible compositions will be given for illustration.

In more detail, the invention preferably contains at least some of the following main elements:

1. For both humans and animals, preferably first the hempseed shells are removed (preferably after first washing them in water, or, more preferably, cleaning them with preferably strong blowing of air, to get rid of any traces of pollen, etc.), preferably by mechanical means, such as for example by friction for example with an abrasive inner surface of a rotating drum or with abrasive rollers. Another possible variation is for example to quickly reduce the seeds'temperature for example by putting them for a very short time in a freezer and then for example shoot them at a hard preferably abrasive surface or hit them with a hard preferably abrasive surface, in order to create cracks in the shell. After the shells are at least partially removed by the cracking and/or abrasive friction, preferably they are further separated for example by using centrifugal forces and/or air currents and/or preferably vibrating screens. Another possible variation is to remove the shells or continue removing what is left of them at stage 2, below. Another possible variation is allowing the seeds to start partially sprouting, which improves digestibility and naturally splits the shells, so that they can be removed for example by water agitation. Another possible variation is soaking the seeds for some time in water and using various enzymes to soften and/or remove the shells. Of course, various combinations of these and additional methods can also be used. This shelling of the seeds is preferably done in conditions of room temperature or lower temperatures and with as little light or no light and as little oxygen or no oxygen as possible, in order to reduce the chance for oxidation. This can be accomplished for example by using a nitrogen-filled air in the production room or in the automatic machines. If some light is used then preferably it is light of red wavelength or darker. Another possible variation is for example to crunch the seeds with the shells and mix them together with the shells.

2. For carnivorous animals food (such as dogs and cats) preferably only part of the hempseed's oil is removed (for example only a third or half of the oil that can be normally extracted this way, but a large range of percents is possible) (preferably by cold-pressing and without chemical extraction, in order to avoid using possibly dangerous chemical solvents which might leave some traces) in order to keep as much nutritients as possible but still increase the relative percent of protein. Preferably the pressing is not too strong, so as not to create heat by the pressing itself. This is no problem, since preferably at most only part of the oil is extracted. The shells or remains of the shells can also be further removed at this stage since this pressing can further break them apart. This pressing of oils is preferably done in conditions of room temperature or lower temperatures and with as little light or no light and as little oxygen or no oxygen as possible, in order to reduce the chance for oxidation. This can be accomplished for example by using a nitrogen-filled air in the production room or in the automatic machine. If some light is used then preferably it is light of red wavelength or darker. Another possible variation is not to remove the oil at all. The resulting products may be even used as baby-food or as food for pregnant or nursing mothers, since the EFA's are very important for the developing brain. Another possible variation, for example when baby food is concerned, is, instead or in addition to pressing the oil, to extract the protein from the seeds for example through a cloth, in a way similar to the production of Soy-milk and Tofu. This milk can also be dried to powder. This way, when substitutes for milk are needed, milk-substitute formulas for babies can be made based on hemp milk instead of soy milk, and preferably the EFA's are added back into the formula.

3. In order to extend shelf life, the seeds are preferably at least partially dehydrated to a certain degree in order to reduce water activity, for example by spray-drying or by pressure and extrusion into a thin sheet of for example 1 mm or less, which can be than be dried for example by air suction or by air-flow, preferably by using air free of oxygen or with reduced amount of oxygen. By increasing the surface area and by preferably allowing only partial dehydration, preferably the dehydration process can be short—preferably less than half an hour, so that it does not damage the nutrients or the flavor. Another possible variation can be for example short exposure to microwave radiation (preferably in a microwave-oven with little or no oxygen) for a short time (such as for example 1 minute or less) preferably not sufficient to denature the seed or damage the nutrients, but preferably sufficient to kill micro-organisms and to also reduce a little further the water content. Another variation of this is for example a short exposure to gamma radiation or other radiations. Of course, this can be also used in addition or in combination with the other methods. However, even without this dehydration, with proper light-free and oxygen-free packaging the seeds at this stage preferably can have a shelf-life of a few months. So the dehydration can be carried out at various levels, including light dehydration or no dehydration at all. Preferably some natural healthy anti-oxidants can also be added at this stage, such as for example Vitamin C (preferably even in large quantities), Vitamin E, Vitamin A, or rice bran (Vitamin E and Carotene are already existent for example in hemp seed, but increasing their quantities may further increase their antioxidant effect. Vitamin C is very important for humans, and even pets benefit from it eventhough they can also create it themselves under certain limitations). If such elements are added, then preferably the seeds are mechanically sizereduced and blended with these ingredients. For pet foods, additional elements, such as for example meat or dried meat or dried meat powder (preferably chicken or fish meat) and/or bones or dried bones and/or dried bone powder and/or some milk powder and/or some eggs or egg powder and/or some algae (preferably for example algae that produce also EPA and DHA), can also be added at this stage in order to increase palatability for carnivore pets. These additives are preferably based on meat and/or bones that are also fit for human consumption, in order not to feed the animals with borderline ingredients, and in order to preferably keep the products also suitable for human consumption. In variations for pets, such as for example dogs and cats, preferably the meat and bones are not cooked, since cooking them is undesirable for their health, and one of the possible variations is even to include whole meaty bones in the product, especially if it is refrigerated. Therefore they may be for example dehydrated, or for example sterilized for a short period for example by gamma radiation or microwave radiation, or simply the pet food is refrigerated (in fish and chickens the danger of parasites or contamination when not cooking is very low if the meat is from a good source). Adding these elements that can increase the protein-like taste of the seeds can also be used instead of reducing the oil content of the seeds. Some other seeds, such as for example flax, primrose, or sesame seed can also be added in order to further enrich the taste and/or add additional nutrients. Also, other nutrients can be added, such as for example various vitamin and/or mineral supplements. Also various starches can be added, such as for example preferably dried whole-wheat cooked bread, and/or various dry cereals (such as for example ground dried cooked whole rice), in order to increase the satiating ability of the products. Also, preferably various types of yeast (preferably brewer's yeast), can also be added, since they have very high nutritional value. Also various fruits and vegetables can be similarly added, however in case of pet food they are preferably thoroughly grinded and preferably very ripe or even over-ripe, since for dogs for example they are much more digestible this way. Another possible variation is that also a small amount of for example salt and/or sugar and/or garlic powder (preferably less than 2% in order to keep the high nutritional value) and/or other solid edible elements and/or hydrolysed proteins can also be added (For example from hemp proteins exposed to appropriate enzyme activity), in order to further reduce the water activity. Another possible variation is that preferably, before or during or after the partial dehydration (or with no dehydration), the material is passed through a pressure-extruding equipment in order to be able to shape it in forms more pleasant for humans or for animals (such as for example squares, pellets, bones, stars, etc.). This pressure is preferably not too strong, so as not to damage the nutrients and not to cause too much internal heating. Preferably also some natural binder such as fish-bone gluten or wheat gluten is added within the mix, or the final extruded particles are dipped into it, in order to help hold it together. Preferably the entire process of stage 3 is also done in conditions of room temperature or lower temperatures and with as little light or no light and as little oxygen or no oxygen as possible

4. The seeds are then preferably packed in oxygen-free and light-opaque packaging, for example by vacuum packing and/or by filling it with other gases, such as for example Nitrogen or Argon or Carbon Dioxide, instead of normal air. If the oil was extracted, then preferably the extracted oil is preferably similarly packaged separately in order to prevent rancidity, and can be sold for example together with the seedbased food, in its separate package. This gives the consumer the added ability to decide independently if and how much oil to add back to the food before consumption, depending for example if it is used for human consumption or for animals, and, if animals, whether they are carnivore animals or not. This flexibility given to the customer is also different from the current state-of-the-art for example in pet foods. If the seeds have been dehydrated at least partially (or if other dry food has been added such as dry meat powder), the consumer may also add back some water before consumption or before giving it to animals, however this may not be needed, especially if it is only partially dehydrated. However, after opening the package, the product is preferably kept refrigerated, since the conditions of excluding oxygen and light no longer apply. Therefore, another possible variation is that the food is preferably divided into smaller compartments within the larger package, such as for example small sized plastic or nylon envelopes, each of them preferably also opaque to light and without oxygen, so that opening the food exposes only the small amount in the smaller compartment. These smaller compartments can be either integral compartments in the larger envelope, for example in the shape of serially connected small cells (for example with perforated lines between each two cells in order to facilitate separation before opening), or small independent envelopes packed freely within the larger envelope (in this case preferably the external larger envelope is stronger than the small internal envelopes in order to protect them against accidental tearing). Preferably the size of the smaller compartments is designed to correspond with more or less one serving of the recommended quantity, so that for example for cat foods the inner envelopes will be typically smaller than for dog foods. Another possible variation is that the extracted oil is also similarly packed for example in small preferably opaque for example plastic or nylon containers, either in a separate large package or together with the small packages of food within the larger package, so that the oil can also conveniently be opened in small dosages instead of exposing the entire supply when opening. In addition, preferably not all servings are the same, so that the diet is preferably balanced between servings and not within each serving. This is very important, since according to the book Give your dog a bone by Dr. Ian Billinghurst (published in Australia in 1993) eating all the time the same “balanced” diet is very undesirable since various nutrients can interact with each other thus reducing the ability of the body to absorb them if they are all fed at the same time, and also the body needs these variation at various feeding times. This is very different from the current state of the art. Another possible variation, especially in versions intended for human consumption, is to keep the product also refrigerated, which can extend shelf-life even further and allow for example mixing with cooked or raw unprocessed meats and/or fish and/or normal eggs instead of dry meats and/or fish and/or egg powder. However, this variation can be used also for animal or pet food—there is no inherent reason why consumers would not buy refrigerated fresh pet foods.

The whole process from start to end preferably takes place in an oxygen-free and light-free environment (for example by using an automated process in an atmosphere that contains for example CO2 or Nitrogen instead of Oxygen) and preferably in room temperatures except for the short exposure to the microwave in the variations where a microwave is used. These principles can be used also for example for improving the process described in PCT application no. WO0150873 by Meir Eini for creating thickened oil compositions of edible oil without destroying the oil. Although that patent tries to solve the problem that solidified oils typically become toxic and carcinogenic by the processes that solidifies them, the alternatives shown in that patent, of adding a solid edible substances to the oils instead of hardening the oils themselves, might also not be completely safe, since in the examples given there the temperatures used for mixing the ingredients are also sometimes dangerous, such as for example 180-200 degrees Celsius for even 30 minutes due to the need to reach the melting point of at least some of the ingredients. Using that process in an automated environment of no oxygen and preferably no light can solve the problem of oxidation during the process.

The above described methods and compositions according to the present invention are further illustrated by the following examples. The examples are intended to be illustrative and should not be interpreted as limiting or otherwise restricting in scope of the invention in any way. For example, some steps can change or be done in a different order, and quantities and times can change. However, since such heating of oils can create dangerous compounds even without oxygen, another possible variation is to use very fast mixing so that the process can be much shorter, and/or mix the oils only with solid oils that have naturally a convenient melting point, such as for example Cocoa butter, which has a melting point of about 34 degrees.

### EXAMPLE 1

The hemp seed shells are mechanically removed and the remaining parts are further separated by air flow and/or screening and/or centrifuge. The shelled seeds are partially cold-pressed for oil, so that for example two thirds of the oil are extracted. The extracted oil is then immediately packaged in opaque and oxygen-free small packages which are then packaged together within a larger and mechanically stronger external envelope. The remaining cake is then pressed into a thin sheet of preferably less than 1 mm in thickness and dried for example for about 30 minutes by room temperature dry air flow (preferably with little or no oxygen) or vacuum suction. The thin partially dehydrated sheet is then mechanically pulverized and preferably thoroughly mixed for example with the following ingredients, so that the final product contains for example (in weight percentages): 50-80% shelled hemp seed, 0-2% salt, 0-2% preferably raw brown sugar, 5-15% preferably dry high-grade poultry meat and bone powder, 5-15% preferably dry high grade fish meal (such as for example Nile fish), 0-15% percent dry cereals or dried cooked whole-wheat, and 1-5% divided between various spices and Vitamins, and preferably especially antioxidant vitamins (such as for example Vitamin C, Vitamin E and Vitamin A), and/or other natural anti-oxidants. The resulting mix is then for example pressure-extruded in the shape of small squares, and covered for example by fresh egg mixed with wheat gluten and warmed for 1 minute in a preferably oxygen-free microwave oven in order to help keep the shape. The resulting product is then immediately packaged in opaque and oxygen-free small packages which are then packaged together in a larger and mechanically stronger external envelope. The whole process from start to end preferably takes place in an oxygen-free and light-free environment (for example by using an automated process in an atmosphere that contains for example C02 or Nitrogen instead of Oxygen) and preferably in room temperatures except for the short exposure to the microwave. When served some water may be added and some of the extracted oil may be also added back and preferably slightly mixed before consumption.

### EXAMPLE 2

Same as example 1, except that only 3% animal meat or bone extracts are added, and 75% of the oil is separated.

### EXAMPLE 3

Same as example 1, except that no animal meat or bone extracts are added at all, and most of the oil is separated, in order to increase the protein-like taste. Some preferably enzymatically hydrolyzed hemp proteins are added in order to improve the taste and various natural flavors and aromas are added.

### EXAMPLE 4

Same as example 1, except that the drying is done after the adding and mixing of the additional ingredients.

### EXAMPLE 5

Same as example 1, except that the cake is heated for a very short time in the microwave oven also immediately before sheet-drying it.

### EXAMPLE 6

Same as example number 1, except that for example more than 50% is based on meat, and only for example 15-20% is hemp seed, and preferably its oil is not extracted at all.

### EXAMPLE 7

Same as example number 6, except that the meat is for example normal non-processed raw or cooked meat (for example chicken), preferably including also whole meaty bones (preferably uncooked, in case of pet food), and the mixture is also kept in mild or strong refrigeration, preferably in addition to packaging in opaque and oxygen free packages.

### EXAMPLE 8

Like example 1 but without the microwave.

### EXAMPLE 9

Like example 1 but without dehydration.

### EXAMPLE 10

Various variations and combinations are created, for example according to some of the above examples, so that for example 5 types of preferably single-serving sub-packages are created. So for example one type of subpackages contains high seed content (preferably hemp) and low meat content, type 2 for example contains mixed amount of meat and hempseed, type 3 contains for example just refrigerated raw meaty bones, type 4 contains for example more starches, and type 5 contains for example more vegetables and fruits, preferably ripe or over-ripe and preferably thoroughly grinded.

While the invention has been described with respect to a limited number of embodiments, it will be appreciated that many variations, modifications, expansions and other applications of the invention may be made which are included within the scope of the present invention, as would be obvious to those skilled in the art.

I claim:

1. A method of preparing stable proteinaceous foods based on any of hempseed and other seeds that do not have the toxins found in Soy, that keeps the seed's nutritional value and do not use dangerous ingredients, such as preservatives and coloring, wherein the processing is done under conditions of any of reduced oxygen, reduced light, and no excessive heat, in order to reduce the chance for oxidation, comprising at least the steps of:
a. Any of removing the hemp seed shells or crashing the seed including the shell into smaller pieces.
b. Creating at least some separation between the oil and the protein parts.

2. The method of claim 1 wherein said shells are mechanically removed.

3. The method of claim 2 wherein the removal is done by friction with an abrasive surface.

4. The method of claim 3 wherein the seeds are also quickly cooled before the mechanical removal of the shells.

5. The method of claim 3 wherein after the applying mechanical friction the shells are further separated by air currents.

6. The method of claim 3 wherein after the applying mechanical friction the shells are further separated by centrifugal forces.

7. The method of claim 3 wherein after the applying mechanical friction the shells are further separated by vibrating screens.

8. The method of claim 3 wherein the seeds are also soaked in water before the removal in order to make the shell weaker.

9. The method of claim 1 wherein all the processing is done under conditions of both reduced light and reduced oxygen.

10. The method of claim 9 wherein the temperatures used do not allow oxidation of the oils and of the nutrients.

11. The method of claim 1 wherein the part of the oil that is extracted is extracted by cold-pressing.

12. The method of claim 1 wherein the proteins are extracted through water and a screen, like in the process for making soy milk.

13. The method of claim 1 wherein the seeds are also dehydrated at least partially.

14. The method of claim 1 wherein animal proteins are also added.

15. The method of claim 1 wherein vitamins are also added.

16. The method of claim 1 wherein cereals are also added.

17. The method of claim 1 wherein wheat gluten is also added as a binder.

18. The method of claim 1 wherein fishbone gluten is also added as a binder.

19. The method of claim 1 wherein the product can be pressure-extruded in various shapes.

20. The method of claim 1 wherein the product is immediately stored in a light-opaque and oxygen-free packaging.

21. The method of claim 20 wherein said packaging is based on inner smaller light-opaque and oxygen free packages within a larger and stronger package, so that only a small part of the product is exposed to light and oxygen for each serving.

22. The method of claim 1 wherein the product is kept in refrigeration.

23. The method of claim 20 wherein the package is also kept in refrigeration.

24. The method of claim 12 wherein the milk is used in a substitute-milk baby formula, and at least part of the extracted hempseed oil is added back into the milk in order to supply the baby with the desired amounts of EFA's.

25. A composition of pet food comprising at least 5% hempseeds, mixed with additional ingredients, without any conservatives and artificial coloring, and without heat damage and oxidation damage to the nutrients and fat of the ingredients.

26. The composition of claim 25 wherein the pet food is sold in light-opaque and oxygen-free packages.

27. The composition of claim 25 wherein the pet food is sold refrigerated.

28. The composition of claim 26 wherein the pet food is sold refrigerated.

29. The composition of claim 25 wherein the pet food can is sold as relatively hard extruded particles with various shapes and sizes, similar to the soy-based pet foods of the state-of the-art.

30. The composition of claim 25 wherein at least part of the hempseed oil is extracted during the preparation.

31. The composition of claim 30 wherein the extracted oil is similarly packaged and sold separately together with the food itself, so that the consumer can decide if and how much oil to add back to the food before serving.

32. The composition of claim 25 wherein the packaging is based on inner smaller light-opaque and oxygen free packages within a larger and stronger package, so that only a small part of the product is exposed to light and oxygen at any time.

33. The composition of claim 32 wherein each inner package is the size of one serving.

34. The composition of claim 32 wherein there are variations in any of ingredients and proportions of ingredients between various types of inner packages within the main package, so that the diet is balanced between inner packages but not necessarily within packages.

35. The composition of claim 25 wherein at least the proteins and oils are not cooked.

36.A composition of substitute-milk baby formula containing at least 5 percent milk extracted from hempseed, and at least 1% extracted hempseed oil in order to supply the baby with the desired amounts of EFA's.

37. The method of claim 13 wherein the dehydration is done by using air free of Oxygen.
